(19) United States
(12) Patent Application Publication
(10) Pub. No.: US 2023/0309561 A1
(43) Pub. Date: Oct. 5, 2023

(54) A METHOD FOR CONTROLLING INSECT PESTS IN COTTON

(71) Applicant: UPL LIMITED, Mumbai (IN)

(72) Inventors: Satish Ekanath BHOGE, Mumbai (IN); Sanjay SARAPH, Mumbai (IN); Sunil NAGANUR, Mumbai (IN)

(21) Appl. No.: 18/041,147

(22) PCT Filed: Aug. 10, 2021
(86) PCT No.: PCT/IB2021/057351

§ 371 Date: Feb. 9, 2023

(30) Foreign Application Priority Data
Aug. 10, 2020 (IN) 202021034295

(51) Int. Cl. A01N 47/02; A01N 25/14; A01N 43/40

(52) U.S. Cl. CPC A01N 47/02; A01N 25/14; A01N 43/40

(57) ABSTRACT

The present disclosure relates to a method for the control of phytopathogenic insects. More particularly, the present disclosure relates to a method of using insecticides for the control of one or more insects in cotton plant.

### FIELD OF THE INVENTION

The present disclosure relates to a method for the control of phytopathogenic insects. More particularly, the present disclosure relates to a method of using insecticides for the control of one or more insects in cotton plants.

### BACKGROUND

Cotton is one of the most important cash crops in India and is the most widely used fiber throughout the world. The United States of America, Uzbekistan, China, India, Brazil, Pakistan, and Turkey are leading countries in the production of cotton. Different parts of the cotton plant, i.e., fiber, linters, and seeds are useful. Fiber is used to make clothes, cellulose from linters is used in plastics, explosives, and other products, and the seeds provide oil, meal and hulls. Like any other plant, cotton is also susceptible to pest infestation. Aphids, Thrips, Jassids, whiteflies, mealy bugs and bollworms infest cotton crop.

Bollworms are the moth larvae that attack the fruiting bodies of certain crops including cotton. Diparopsis castanea, Earias perhuegeli, Earias fabia, Earias insulana, Earias vittella, Helicoverpa armigera, Helicoverpa gelotopoeon, Helicoverpa punctigera, Helicoverpa zea, Heliothis virescens, Pectinophora gossypiella, and Pectinophora scutigera are some of the common bollworms. Damage done by Pectinophora gossypiella (pink bollworm) includes rosetted flowers, damaged seed kernels, formation of double seeds, dropping of immature bolls, discoloured lint and burrowed seeds, whereas damage done by Earias vittella (spotted bollworms) includes drying and drooping of terminal shoots before flowering, shedding of squares and young bolls, flared squares, holed and rotten bolls.

Whiteflies are sucking pests that attack certain crops including cotton. They excrete a sticky sugary liquid called honeydew and cause yellowing or death of leaves. Honeydew attracts ants that interfere with functioning of natural enemies that may control whiteflies and other pests.

Natural enemies of insect pests, also called as biological control agents, are the living organisms that are extremely important for reducing the number of pests. Parasitoids such as parasitic wasps, tachinid flies, and rove beetles, pathogens such as Bacillus thuringiensis, and predators such as ladybugs, predatory beetles, predatory mites, and spiders are all examples of natural enemies.

Fipronil, also known as 5-amino-1-[2,6-dichloro-4-(trifluoromethyl)phenyl]-4-[(RS)-(trifluoromethyl)sulfinyl]-1H-pyrazole-3-carbonitrile, is a phenylpyrazole insecticide.

Flonicamid, also known as 5-amino-1-[2,6-dichloro-4-(trifluoromethyl)phenyl]-4-[(RS)-(trifluoromethyl)sulfinyl]-1H-pyrazole-3-carbonitrile, is a pyridine insecticide.

All the aforementioned options for controlling whiteflies and spotted bollworms have one or more drawbacks such as less bio-efficacy, high phytotoxicity, and unfavourable effects on natural enemies.

Methods of controlling pests in cotton plants have been developed and are in practice. However, methods that show better bio-efficacy along with other benefits such as less or no phytotoxicity, less or no effect on natural enemies, and improved yield and cost benefit ratio are still being sought and are extremely difficult to find.

There is therefore a need in the art for an insecticide that can be used to control one or more of spotted bollworms, pink bollworms, whiteflies, jassids, and thrips, wherein the insecticide shows excellent bio-efficacy, reduced or no phytotoxicity, reduced or no effect on natural enemies of cotton pests, and which provides improved yield and an improved cost benefit ratio.

### OBJECTIVES OF THE DISCLOSURE

The present disclosure, described hereinafter, achieves at least one of the following objectives.

It is an objective of the present disclosure to provide a method of controlling insect pests, particularly one or more of spotted bollworms, pink bollworms, whiteflies, jassids and thrips in plants.

It is an objective of the present disclosure to provide a method of controlling insect pests, particularly one or more of spotted bollworms, pink bollworms, whiteflies, jassids and thrips in cotton plants.

It is an objective of the present disclosure to provide a method of controlling insect pests, particularly one or more of spotted bollworms, pink bollworms, whiteflies, jassids and thrips in cotton plants that also exhibits a favourable effect on natural enemies of cotton pests such as spiders, chrysopids and coccinellids.

It is an objective of the present disclosure to provide a method of controlling insect pests, particularly one or more of spotted bollworms, pink bollworms, whiteflies, jassids and thrips in cotton plants that also shows no or less phytotoxic effect.

It is an objective of the present disclosure to provide a method of controlling insect pests, particularly one or more of spotted bollworms, pink bollworms, whiteflies, jassids and thrips in cotton plants that also results in improved cotton yield.

It is an objective of the present disclosure to provide a method of controlling insect pests, particularly one or more of spotted bollworms, pink bollworms, whiteflies, jassids and thrips in cotton plants and provides improved cost benefit ratio.

### SUMMARY OF THE DISCLOSURE

In an aspect, the present disclosure provides a method of controlling pests, particularly one or more of spotted bollworms, pink bollworms, whiteflies, jassids and thrips in plants, said method comprising treating a crop with a combination comprising fipronil and flonicamid.

In an aspect, the present disclosure provides a method of controlling insect pests, particularly one or more of spotted bollworms, pink bollworms, whiteflies, jassids and thrips in plants, said method comprising treating a cotton crop with a combination comprising fipronil and flonicamid.

In an aspect, the present disclosure provides a method of controlling insect pests, particularly one or more of spotted bollworms, pink bollworms, whiteflies, jassids and thrips, said method comprising treating a cotton crop with a combination comprising fipronil and flonicamid, wherein fipronil is applied at a dose of 75 g/ha of fipronil.

In an aspect, the present disclosure provides a method of controlling insect pests, particularly one or more of spotted bollworms, pink bollworms, whiteflies, jassids and thrips, said method comprising treating a cotton crop with a combination comprising fipronil and flonicamid, wherein flonicamid is applied at a dose of 75 g/ha of flonicamid.

In an aspect, the present disclosure provides a method for controlling insect pests, particularly one or more of spotted bollworms, pink bollworms, whiteflies, jassids and thrips, said method comprising treating a cotton crop with a combination of 75 g/ha of fipronil and 75 g/ha of flonicamid.

In an aspect, the present disclosure provides a method for controlling insect pests, particularly one or more of spotted bollworms, pink bollworms, whiteflies, jassids and thrips in cotton plants that also exhibits a favourable effect on natural enemies of cotton pests such as spiders, chrysopids and coccinellids, said method comprising treating a crop with a combination comprising fipronil and flonicamid.

In an aspect, the present disclosure provides a method for controlling insect pests, particularly one or more of spotted bollworms, pink bollworms, whiteflies, jassids and thrips, said method comprising treating a crop with a wettable granular formulation comprising fipronil and flonicamid.

In an aspect, the present disclosure provides a method for controlling one or more of spotted bollworms, pink bollworms, whiteflies, jassids, and thrips, said method comprising treating a cotton crop with a wettable granular formulation comprising fipronil and flonicamid at the rate of 500 g/ha.

In an aspect, the present disclosure provides a method for controlling one or more of spotted bollworms, pink bollworms, whiteflies, jassids and thrips, said method comprising treating a cotton crop with a wettable granular formulation comprising 15 wt % fipronil and 15 wt % flonicamid.

### DETAILED DESCRIPTION OF DISCLOSURE

As used herein, the term “pest” refers to an organism, and in particular an insect, which is detrimental to the growth, reproduction, and/or viability of a plant, a portion of the plant or a plant seed. In an aspect, the pest is an insect pest such as a spotted bollworm, a pink bollworm, a whitefly, a jassid, and/or a thrip. In an aspect, the plant is a cotton plant.

As used herein, the term “control” as it relates to a pest, includes the killing of the pest, as well as protecting a plant, a portion of the plant, or a plant seed from attack or invasion by said pest.

It has surprisingly been found by the inventors that the combination of fipronil with flonicamid effectively controls the whitefly and spotted bollworm population in cotton plants while being economical, and showing reduced phytotoxicity and improved yield. This effective control which is synergistic in nature was not seen when either the fipronil suspension concentrate (SC) or flonicamid wettable granular formulation (WG) were individually used in isolation (on their own), but was observed when the two insecticides were used in combination in a wettable granular formulation. This synergistic complementation between the fipronil and flonicamid was unexpected and surprising.

In an embodiment, fipronil and flonicamid are applied as a wettable granular formulation.

In an embodiment, the wettable granular formulation comprises fipronil in an amount of 10 weight percent (wt %) to 20 wt %, or 12 wt % to 18 wt %, or 13 wt % to 17 wt %, or 14 wt % to 16 wt %, based on the total weight of the wettable granular formulation. In an embodiment, the wettable granular formulation comprises flonicamid in an amount of 10 wt % to 20 wt %, or 12 wt % to 18 wt %, or 13 wt % to 17 wt %, or 14 wt % to 16 wt %, based on the total weight of the wettable granular formulation. As used herein, the weight percentage is based on the total weight of the wettable granular formulation.

In another embodiment of the disclosure, the wettable granular formulation comprises 15 wt % fipronil and 15 wt % flonicamid, based on the total weight of the wettable granular formulation.

In still another embodiment of the disclosure, the wettable granular formulation comprising fipronil and flonicamid is applied at an application rate in the range of 300 to 1000 grams per hectare (g/ha), or 400 to 600 g/ha, or 400 to 500 g/ha. In an embodiment, the wettable granular formulation is applied to locules of the cotton crop at rate of 500 g/ha.

In still another embodiment of the disclosure, the wettable granular formulation comprises 15 wt % fipronil and 15 wt % flonicamid, based on the total weight of the wettable granular formulation, wherein fipronil is applied at a dose of 45 to 100 g/ha, or 60 to 80 g/ha, or 70 to 80 g/ha. In an embodiment the fipronil is applied at a dose of 75 g/ha.

In still another embodiment of the disclosure, the wettable granular formulation comprises 15 wt % fipronil and 15 wt % flonicamid, based on the total weight of the wettable granular formulation, wherein flonicamid is applied at a dose of 45 to 100 g/ha, or 60 to 80 g/ha, or 70 to 80 g/ha. In an embodiment the flonicamid is applied at a dose of 75 g/ha.

In still another embodiment of the disclosure, the wettable granular formulation comprises 15 wt % fipronil and 15 wt % flonicamid, wherein fipronil and flonicamid are both are applied at a dose of 75 g/ha each.

In still another embodiment of the disclosure, the wettable granular formulation comprising 15 wt % fipronil and 15 wt % flonicamid is applied to control spotted bollworm.

In still another embodiment of the disclosure, the wettable granular formulation comprising 15 wt % fipronil and 15 wt % flonicamid is applied to control whiteflies.

In still another embodiment of the disclosure, the wettable granular formulation comprising 15 wt % fipronil and 15 wt % flonicamid is applied to control jassids.

In still another embodiment of the disclosure, the wettable granular formulation comprising 15 wt % fipronil and 15 wt % flonicamid is applied to control thrips.

In still another embodiment of the disclosure, the wettable granular formulation comprising 15 wt % fipronil and 15 wt % flonicamid is applied to control pink bollworms.

In still another embodiment of the disclosure, the wettable granular formulation comprising 15 wt % fipronil and 15 wt % flonicamid is applied to control spotted bollworms, pink bollworms, whiteflies, jassids and thrips in cotton plants, and exhibits a favourable effect on natural enemies of cotton pests such as spiders, chrysopids and coccinellids.

In an embodiment, the disclosed wettable granular formulations are synergistic in controlling insect pests as compared to contacting the insect pests with a wettable granular flonicamid formulation or a suspension concentrate fipronil formulation.

In an embodiment, the disclosed wettable granular formulations exhibit synergistic control of whitefly and/or spotted bollworm in cotton plants, and non-synergistic control of jassids or thrips. In an embodiment, the disclosed wettable granular formulations exhibit synergistic control of whitefly and/or spotted bollworm in cotton plants.

“Synergistic control” is present when the observed efficacy of the wettable granular formulation comprising the combination of finopril and flonicamid is greater than the expected efficacy. The expected efficacy (E) is calculated using the following equation also called as Colby's formula:

E=(X+Y)−XY/100

In the above equation, X is the efficacy of a formulation including only finopril and Y is the efficacy of a formulation including only flonicamid.

In an embodiment, yield of seed cotton (cottonseed) from a cotton crop treated with the disclosed wettable granular formulation is at least 10% greater, preferably 15% greater, still more preferably 20% greater than yield of seed cotton from an untreated cotton crop.

The pesticidal composition of the present disclosure can protect cotton plants from damage caused by the pests, for example, harmful arthropods such as harmful insects and harmful mites, which cause damage by feeding and/or sucking to plants.

As will be demonstrated in the examples, the combination of fipronil and flonicamid, greatly improved the whitefly and spotted bollworm control as well as improved the yield of the cotton plants (cotton crop). The combination did not show any phytotoxicity. The method of the present disclosure also yielded favourable results against natural enemies of the pests. For example, there is no significant difference in the number of natural enemies present in cotton plants treated with the disclosed wet granular formulations as compared to untreated cotton plants.

The method of the present disclosure improves the existing disease control to an unexpectedly high degree and surprisingly improves the yield obtained in an economical way.

According to the present disclosure, a composition for controlling pests having excellent control efficacy for pests and a method effective for controlling pests can be provided.

These and other advantages of the disclosure may become more apparent from the examples set forth herein below. These examples are provided merely as illustrations of the disclosure and are not intended to be construed as a limitation thereof.

### EXAMPLES

Experiments were carried out to evaluate the bio-efficacy of combination of fipronil and flonicamid against the spotted bollworms, pink bollworms, whiteflies, jassids and thrips on cotton plant.

Total four applications of prescribed treatments were made at an average of 15 days interval using a hand operated, high volume Knapsack sprayer. The first three serial applications were done to control sucking pests and the last three sprays were done to control bollworm complex.

Pre- and post-treatment observations on the sucking pest population, i.e. jassids, whiteflies, aphids and thrips, were recorded on 3 leaves selected randomly from the top, middle, and bottom of 5 randomly selected plants in each plot before spray and at 3, 7, and 12 days after spray (DAS). Observations recorded before spray were transformed to square root, however, data presented in percent population reduction were transformed to arcsin for statistical analysis. The spotted bollworm population was counted on 5 randomly selected plants in each plot at 10 days after each spray, while 20 green bolls were picked at 10 days after each spray from 5 randomly selected plants and dissected for recording of the pink bollworm population. Percent green boll and open boll damage, as well as locule damage, were also recorded. Observations were transformed to arcsin for statistical analysis.

Phytotoxicity symptoms such as leaf injury on tips/surface, necrosis, wilting, epinasty, and hyponasty were recorded at 3, 5, and 7 days after spray.

Observations were also taken to determine the effect of treatment on the natural enemies of pests in the cotton crop, i.e., predators and parasites. 5 plants per plot were randomly selected and tagged for recording the population of crysopids, coccinellids, and spiders at 3, 7 and 12 days after spray. The results were transformed to square root for statistical analysis.

Seed cotton yield was also recorded at picking time and presented in the form of quintal per hectare. Cost benefit ratio was also calculated for each treatment.

Efficacy of different treatments in controlling the cotton insect pests was analyzed by analysis of variance.

Treatments were designed to compare the performance of single active formulations (5% fipronil SC or flonicamid 50% WG), the commercially marketed product Thiamethoxam 25% WG (3-[(2-chloro-5-thiazolyl)methyl]tetrahydro-5-methyl-N-nitro-4H-1,3,5-oxadiazin-4-imine), and the combination of fipronil and flonicamid (15 wt % fipronil+15 wt % flonicamid, WG).

Below Table 1 provides a summary of the formulation treatments. For the WG formulations, the percentage of active ingredient is a weight percent based on the total weight of the WG formulation. For the SC formulation, the percentage of active ingredient is the weight percent based on the total volume of the SC formulation.

TABLE 1
Formulations

| | | Total Dose | Active |
|---|---|---|---|
| | | of active | ingredient |
| Sr. | | ingredients | concentration |
| No. | Treatment | (ml or g/ha) | (ml or g/ha) |
| 1 | 15% Fipronil + 15% Flonicamid, WG | 300 | 90 |
| 2. | 15% Fipronil + 15% Flonicamid, WG | 400 | 120 |
| 3. | 15% Fipronil + 15% Flonicamid, WG | 500 | 150 |
| 4 | Flonicamid 50% WG | 150 | 75 |
| 5. | Fipronil 5% SC | 1500 | 75 |
| 6. | Thiamethoxam 25% WG | 100 | 25 |
| 7. | Untreated Control | — | — |

Evaluation of Bio-efficacy of Fipronil+Flonicamid WG:

TABLE 2
Bio-efficacy against jassids on cotton plant

| | | | Jassid | Jassid population | | | |
|---|---|---|---|---|---|---|---|
| | | Total Dose | population | Percent Reduction | | | |
| Sr. | | of actives | (Before | | | 12 | |
| No. | Treatment | ml or g/ha | spray) | 3 DAS | 7 DAS | DAS | Mean |
| 1. | 15% Fipronil + 15% | 300 | 29.67 | 72.84 | 85.19 | 64.38 | 74.14 |
| | Flonicamid, WG | | | | | | |
| 2. | 15% Fipronil + 15% | 400 | 29.00 | 75.93 | 92.52 | 68.99 | 79.15 |
| | Flonicamid, WG | | | | | | |
| 3 | 15% Fipronil + 15% | 500 | 33.33 | 76.03 | 93.23 | 69.53 | 79.60 |
| | Flonicamid, WG | | | | | | |
| 4. | Flonicamid 50% WG | 150 | 30.67 | 67.69 | 74.24 | 61.71 | 67.88 |
| 5 | Fipronil 5% SC | 1500 | 32.00 | 63.63 | 59.89 | 55.09 | 59.54 |
| 6. | Thiamethoxam 25% WG | 100 | 31.67 | 71.67 | 68.39 | 63.74 | 67.93 |
| 7. | Untreated Control | — | 30.00 | 0.00 | 0.00 | 0.00 | 0.00 |

| | | | | | | |
|---|---|---|---|---|---|---|
| SEM± | — | NS | (0.75) | (2.10) | (1.03) | — |
| CD at 5% | — | NS | (2.00) | (6.40) | (3.10) | — |

DAS: Days after spray,
NS: Non-significant

Conclusion: It is concluded from the above results in Table 2 that the jassids population was found to be uniform in the main field and ranged from between 29.00 to 33.33 jassids per 15 leaves before the application of the insecticide sprays. The jassids population was found to increase and was above economic threshold Level (ETL) throughout the trial period. The data presented in above Table 2 showed that the maximum mean jassids population reductions were 76.03, 93.23 and 69.53 percent, and were recorded for the treatment containing 15% Fipronil+15% Flonicamid, WG applied at the rate of 500 g/ha at 3^{rd}, 7^{th} and 12^{th} days after each sprays, respectively. The next greatest reduction in jassid population was observed for the treatment of 15% Fipronil+15% Flonicamid, WG applied at the rate of 400 g/ha with 75.93, 92.52 and 68.99 percent at 3^{rd}, 7^{th} and 12^{th} days after each sprays, respectively. Treatment with the lower dose of 15% Fipronil+15% Flonicamid, WG at the rate of 300 g/ha, treatment with Thiamethoxam 25% WG at the rate of 100 g/ha, and treatment with Flonicamid 50% WG at the rate of 150 g/ha, were found next in order of effectiveness with 72.84, 85.19 and 64.38 percent, 71.67. 68.39 and 63.74 percent, and 67.69, 74.24 and 61.71 percent population reduction after each spray, respectively. Standard treatment with Fipronil 5% SC at the rate of 1500 ml/ha was found to be less effective compared to the other treatments, however, was superior to the untreated control. All three doses of 15% Fipronil+15% Flonicamid, WG were found to be effective compared to the solo formulations.

The effectiveness of all treatments as measured by percent reduction in the jassid population, was also evaluated according to Colby's equation. In Colby's equation given below, E is the expected efficacy of combination of fipronil and flonicamid, X is the observed efficacy of fipronil SC, and Y is the observed efficacy of flonicamid WG. Observed efficacy values (i.e. X and Y) are respective mean values of percent population reduction for fipronil SC and flonicamid WG. If observed efficacy of the combination of fipronil and flonicamid was greater than its expected efficacy, then the combination was determined to be synergistic. If observed efficacy was equal to or less than the expected efficacy, then combination was determined to non-synergistic.

Colby's equation:

E=(X+Y)−XY/100

Therefore, the expected efficacy of 15% Fipronil+15% Flonicamid WG is calculated as below.

E=59.54+67.88−(59.54×67.88/100); i.e.,87.01%

Observed and expected efficacies were then compared for each of the combination formulations.

TABLE 3
Comparison of observed and expected efficacy of 15% Fipronil +
15% Flonicamid WG against jassids in cotton plants

| | | Observed | Expected | Difference between |
|---|---|---|---|---|
| Sr. | | efficacy in | efficacy in | observed and actual |
| No. | Treatment | percentage | percentage | efficacy in percentage |
| 1. | 15% Fipronil + 15% | 74.14 | 87.01 | −12.87 |
| | Flonicamid, WG at the | | | |
| | rate of 300 ml or g/ha | | | |
| 2. | 15% Fipronil + 15% | 79.15 | | −7.86 |
| | Flonicamid WG at the | | | |
| | rate of 400 ml or g/ha | | | |
| 3. | 15% Fipronil + 15% | 79.60 | | −7.41 |
| | Flonicamid WG at the | | | |
| | rate of 500 ml or g/ha | | | |

Based on the information in above Table 3, the combination of 15% fipronil and 15% flonicamid, WG was determined to be non-synergistic in the control of the jassids population in cotton plants.

TABLE 4
Bio-efficacy against whitefly on cotton plant

| | | | Whitefly | Whitefly population | | | |
|---|---|---|---|---|---|---|---|
| | | Total Dose | population | Percent reduction | | | |
| Sr. | | of actives | (Before | | | 12 | |
| No. | Treatment | ml or g/ha | spray) | 3 DAS | 7 DAS | DAS | Mean |
| 1. | 15% Fipronil + 15% | 300 | 85.67 | 70.04 | 77.68 | 61.97 | 69.90 |
| | Flonicamid, WG | | | | | | |
| 2. | 15% Fipronil + 15% | 400 | 79.33 | 73.34 | 81.10 | 66.65 | 73.70 |
| | Flonicamid, WG | | | | | | |
| 3. | 15% Fipronil + 15% | 500 | 83.33 | 74.64 | 82.31 | 67.87 | 74.94 |
| | Flonicamid, WG | | | | | | |
| 4. | Flonicamid 50% WG | 150 | 86.00 | 65.45 | 69.11 | 58.16 | 64.24 |
| 5. | Fipronil 5% SC | 1500 | 82.67 | 20.18 | 23.01 | 14.64 | 19.27 |
| 6. | Thiamethoxam 25% WG | 100 | 86.33 | 71.43 | 67.88 | 63.60 | 67.64 |
| 7. | Untreated Control | — | 85.67 | 0.00 | 0.00 | 0.00 | 0.00 |

| | | | | | | |
|---|---|---|---|---|---|---|
| SEM± | — | NS | (0.95) | (1.05) | (1.00) | — |
| CD at 5% | — | NS | (2.90) | (3.30) | (3.45) | — |

Values are mean of three spray and three replications.
DAS: Days after spray,
NS: Non-significant.

Whitefly population was found uniform in the main field and ranged between 79.33 to 86.33 whiteflies per 15 leaves before application of the insecticide sprays. Whitefly population was found to increase and was above the economic threshold level (ETL) throughout the trial period. The data presented in above table showed that the maximum mean whitefly population reductions were of 74.64, 82.31 and 67.87 percent, and were recorded for the treatment containing 15% Fipronil+15% Flonicamid, WG applied at the rate of 500 g/ha at 3^{rd}, 7^{th} and 12^{th} days after each sprays, respectively. The next greatest reduction in whitefly population was observed for the treatment having 15% Fipronil+15% Flonicamid, WG at the rate of 400 g/ha with 73.34, 81.10 and 66.65 percent reduction at 3^{rd}, 7^{th} and 12^{th} days after each sprays, respectively. Treatment with the lower dose of 15% Fipronil+15% Flonicamid WG at the rate of 300 g/ha, treatment with Thiamethoxam 25% WG at the rate of 100 g/ha, and treatment with flonicamid 50% WG at the rate of 150 g/ha, were found next in order of effectiveness with 70.04, 77.68 and 61.97 percent, 71.43, 67.88 and 63 60 percent, and 65.45, 69.1 and 58.16 percent population reduction at 3^{rd}, 7^{th} and 12^{th} days after each sprays, respectively. Standard treatment with Fipronil 5% SC applied at the rate of 1500 ml/ha was found to be less effective compared to the other treatments, however, was superior to the untreated control. All three doses of 15% Fipronil+15% Flonicamid, WG were found to be effective compared to the solo formulations.

This effectiveness of all treatments as measured by percent reduction in the whitefly population, was also evaluated according to Colby's equation as below.

E=19.27+64.24−(19.27×64.24)/100, i.e. 71.14

Efficacy values are respective values are percent population reduction. Observed and expected efficacies were then compared for combination.

TABLE 5
Observed and expected efficacy of 15% Fipronil +
15% Flonicamid WG against whitefly in cotton

| | | Observed | Expected | Difference between |
|---|---|---|---|---|
| Sr. | | efficacy in | efficacy in | observed and actual |
| No. | Treatment | percentage | percentage | efficacy in percentage |
| 1 | 15% Fipronil + 15% | 69.90 | 71.14 | −1.24 |
| | Flonicamid WG at the | | | |
| | rate of 300 ml or g/ha | | | |
| 2. | 15% Fipronil + 15% | 73.70 | | 2.56 |
| | Flonicamid WG at the | | | |
| | rate of 400 ml or g/ha | | | |
| 3. | 15% Fipronil + 15% | 74.94 | | 3.8 |
| | Flonicamid WG at the | | | |
| | rate of 500 ml or g/ha | | | |

Based on the information in above Table 5, the combination of 15% fipronil and 15% flonicamid, WG, applied at 400 ml or g/ha or at 500 ml or g/ha, was determined to be synergistic in the control of the whitefly population in cotton plants.

3. Bio-efficacy against Thrips on cotton plant.

TABLE 6

| | | | Thrips | Thrips population | | | |
|---|---|---|---|---|---|---|---|
| | | Dose | population | Percent reduction | | | |
| Sr. | | ml or | (Before | | | 12 | |
| No. | Treatment | g/ha | spray) | 3 DAS | 7 DAS | DAS | Mean |
| 1 | 15% Fipronil + 15% | 300 | 125.00 | 74.81 | 80.20 | 68.21 | 74.41 |
| | Flonicamid, WG | | | | | | |
| 2 | 15% Fipronil + 15% | 400 | 125.67 | 78.92 | 86.88 | 73.12 | 79.64 |
| | Flonicamid, WG | | | | | | |
| 3 | 15% Fipronil + 15% | 500 | 137.67 | 80.25 | 87.10 | 73.83 | 80.39 |
| | Flonicamid, WG | | | | | | |
| 4. | Flonicamid 50% WG | 150 | 138.00 | 37.31 | 32.44 | 27.11 | 80.39 |
| 5. | Fipronil 5% SC | 1500 | 135.33 | 74.78 | 80.50 | 70.62 | 75.30 |
| 6. | Thiamethoxam 25% WG | 100 | 133.00 | 68.71 | 68.90 | 67.12 | 68.24 |
| 7. | Untreated | — | 137.67 | 0.00 | 0.00 | 0.00 | 0.00 |
| | Control | | | | | | |

| | | | | | | |
|---|---|---|---|---|---|---|
| SEM± | — | NS | (1.22) | (1.85) | (1.15) | — |
| CD at 5% | — | NS | (3.72) | (5.30) | (3.50) | — |

Values are mean of three spray and three replications.
DAS: Days after spray,
NS: Non-significant

Thrips population was found uniform in the main field and ranged from between 125.00 to 138.00 thrips per 15 leaves before application of the insecticide sprays. Thrips population was found increase and was above economic threshold level (ETL) throughout the trial period. All insecticidal treatments significantly reduced the Thrips population effectively, however, the maximum mean Thrips population reductions were 80.25, 87.10, and 73.83 percent, and were recorded for the treatment containing 15% Fipronil+15% Flonicamid, WG applied at the rate of 500 g/ha at 3^{rd}, 7^{th} and 12^{th} days after each sprays, respectively. The next greatest reduction in thrips population was observed for the treatment of 15% Fipronil+15% Flonicamid, WG at the rate of 400 g/ha with 78.92, 86.88 and 73.12 percent reduction at 3^{rd}, 7^{th} and 12^{th} days after each sprays, respectively. Treatment with the lower dose of 15% Fipronil+15% Flonicamid, WG applied at the rate of 300 g/ha with 74.81, 80.20 and 68.21 percent reduction, treatment with standard check, Fipronil 5% SC applied at the rate of 1500 ml/ha with 74.78, 80.50 and 70.62 percent reduction, treatment with Thiamethoxam 25% WG at the rate of 100 g/ha with 68.71, 68.90 and 67.12 percent reduction, and treatment with Flonicamid 50% WG at the rate of 150 g/ha resulted in 72.61, 79.96 and 65.53 percent reduction, and were found to be on par with one another irrespective of the number of sprays and day interval of observations.

This effectiveness of all treatments was also evaluated according to Colby's equation as below.

E=75.30+80.39−(75.30×80.39)/100; i.e., 95.16%

Efficacy values are respective values are percent population reduction. Observed and expected efficacies were then compared for combination.

TABLE 7
Observed and expected efficacy of 15% Fipronil +
15% Flonicamid WG against thrips in cotton

| | | Observed | Expected | Difference between |
|---|---|---|---|---|
| Sr. | | efficacy in | efficacy in | observed and actual |
| No. | Treatment | percentage | percentage | efficacy in percentage |
| 1. | 15% Fipronil + 15% | 74.41 | 95.16 | −20.75 |
| | Flonicamid, WG at the | | | |
| | rate of 300 ml or g/ha | | | |
| 2. | 15% Fipronil + 15% | 79.64 | | −15.52 |
| | Flonicamid, WG at the | | | |
| | rate of 400 ml or g/ha | | | |
| 3. | 15% Fipronil + 15% | 80.39 | | −14.77 |
| | Flonicamid, WG at the | | | |
| | rate of 500 ml or g/ha | | | |

Based on the information in above Table 7, the combination of 15% fipronil and 15% flonicamid, WG was determined to be non-synergistic in the control of thrips population in cotton plants.

TABLE 8
Bio-efficacy against spotted bollworm on cotton plants

| | | Total | | | | |
|---|---|---|---|---|---|---|
| | | Dose of | Percent | | | |
| | | actives | population Reduction | | | |
| Sr. | | ml or | 10 | 10 | 10 | |
| No. | Treatment | g/ha | DASS | DATS | DAFS | Mean |
| 1. | 15% Fipronil + 15% | 300 | 66.67 | 68.44 | 65.89 | 67.00 |
| | Flonicamid, WG | | | | | |
| 2. | 15% Fipronil + 15% | 400 | 70.56 | 75.07 | 72.59 | 72.74 |
| | Flonicamid, WG | | | | | |
| 3 | 15% Fipronil + 15% | 500 | 74.89 | 77.33 | 74.07 | 75.43 |
| | Flonicamid, WG | | | | | |
| 4. | Flonicamid 50% WG | 150 | 8.33 | 10.48 | 8.59 | 9.13 |
| 5. | Fipronil 5% SC | 1500 | 67:07 | 72.69 | 69:67 | 69.81 |
| 6. | Thiamethoxam 25% | 100 | 5.00 | 6.84 | 4.22 | 5.35 |
| | WG | | | | | |
| 7. | Untreated Control | — | 0.00 | 0.00 | 0.00 | 0.00 |

| | | | | | |
|---|---|---|---|---|---|
| SEM± | — | (1.74) | (1.88) | (1.69) | — |
| CD at 5% | — | (5.10) | (5.65) | (5.08) | — |

Values are mean of three spray and three replications.
DASS: Days after second spray,
DATS: Days after third spray,
DAFS: Days after first spray,
NS: Non-significant

### Spotted Bollworm (Earias spp.)

The incidence of spotted bollworm was noticed at time of second spray onward during both seasons. The data presented in above Table 8 showed that the maximum spotted bollworm population reduction was of 72.22, 76.72 and 74.76 percent recorded at 10 days after second, third and fourth sprays, respectively, for the treatment containing 15% Fipronil+15% Flonicamid, WG at the rate of 500 g/ha. The treatment of 15% Fipronil+15% Flonicamid, WG at the rate of 500 g/ha was found to be on par with 15% Fipronil+15% Flonicamid, WG at the rate of 400 g/ha with 70.57, 75.61 and 73.78 percent reduction al 10 days after second, third and fourth sprays, respectively. Treatment having the lower dose of 15% Fipronil+15% Flonicamid, WG at the rate of 300 g/ha and the treatment of Fipronil 5% SC at the rate of 1500 ml/ha were found to be at par with one another and recorded the next effective treatments to control spotted bollworm populations. Standard checks, Flonicamid 50% WG at the rate of 150 g/ha and Thiamethoxam 25% WG at the rate of 100 g/ha failed to control spotted bollworm populations. However, they were superior to untreated control.

This effectiveness of all treatments was also evaluated according to Colby's equation. In the Colby's equation given below, E is the expected efficacy of combination of fipronil and flonicamid, X is the observed efficacy of flonicamid SC and Y is the observed efficacy of fipronil WG. If observed efficacy of combination of fipronil and flonicamid was greater than expected efficacy, then combination was determined to be synergistic. If observed efficacy was equal to or less than expected, then combination was determined to non-synergistic.

Colby's equation

E=X+Y−XY/100

Therefore, expected efficacy of 15% Fipronil+15% Flonicamid WG is calculated as below.

E=69.81+9.13−(69.81×9.13)/100: i.e., 72.57%

Efficacy values are respective values are percent population reduction.

TABLE 9
Observed and expected efficacy of 15% Fipronil +
15% Flonicamid WG against spotted bollworm in cotton

| | | Observed | Expected | Difference between |
|---|---|---|---|---|
| Sr. | | efficacy in | efficacy in | observed and actual |
| No. | Treatment | percentage | percentage | efficacy in percentage |
| 1. | 15% Fipronil + 15% | 67.00 | 72.57 | −5.57 |
| | Flonicamid, WG at the | | | |
| | rate of 300 ml or g/ha | | | |
| 2. | 15% Fipronil + 15% | 72.74 | | 0.17 |
| | Flonicamid, WG at the | | | |
| | rate of 400 ml or g/ha | | | |
| 3 | 15% Fipronil + 15% | 75.43 | | 2.86 |
| | Flonicamid, WG at the | | | |
| | rate of 500 ml or g/ha | | | |

Based on the information in above Table 9, the combination of 15% fipronil and 15% flonicamid, WG when administered at the rate of 400 or 500 ml or g/ha or was determined to be synergistic in the control of spotted bollworm population in cotton plants.

TABLE 10
Evaluation of boll and locule damage due to pink boll worms in cotton plants

| | | Total Dose | Open boll damage (%) | | | |
|---|---|---|---|---|---|---|
| Sr. | | of actives | Boll basis | Locule Basis | Yield | CB |
| No. | Treatment | ml or g/ha | Boll basis | Locule Basis | q/ha | Ratio |
| 1. | 15% Fipronil + 15% Flonicamid, | 300 | 9.33 | 4.26 | 14.60 | 1:2.19 |
| | WG | | | | | |
| 2. | 15% Fipronil + 15% Flonicamid, | 400 | 7.33 | 3.71 | 15.36 | 1:2.23 |
| | WG | | | | | |
| 3. | 15% Fipronil + 15% Flonicamid, | 500 | 6.33 | 3.08 | 15.67 | 1:2.21 |
| | WG | | | | | |
| 4. | Flonicamid 50% WG | 150 | 19.67 | 9.15 | 13.71 | 1:1.97 |
| 5. | Fipronil 5% SC | 1500 | 7.00 | 4.05 | 14.44 | 1:1.87 |
| 6. | Thiamethoxam 25% WG | 100 | 23.33 | 11.60 | 13.42 | 1:2.14 |
| 7. | Untreated Control | — | 24.00 | 12.97 | 11.82 | 1:1.95 |

| | | | | |
|---|---|---|---|---|
| SEM± | — | (1.00) | (0.58) | (0.33) |
| CD at 5% | — | (3.20) | (1.75) | (1.05) |

Values are mean of three replications.

Bollworm Damage due to Pink Bollworm (Pectinophora gossypiella)

Minimum open bolls and locule damage was recorded in the treatment containing 15% Fipronil+15% Flonicamid, WG applied at the rate of 500 g/ha with 6.33 and 3.08 percent. The treatment 15% Fipronil+15% Flonicamid, WG applied at the rate of 500 g/ha was at par with 15% Fipronil+15% Flonicamid, WG applied at the rate of 400 g/ha with 7.33 open bolls damage and 3.71 percent locule damage.

Standard check. Fipronil 5% SC applied at the rate of 1500 ml/ha was found to be the next effective treatment to reduce open boll and locule damage. Treatment with Flonicamid 50% WG applied at the rate of 150 g/ha and treatment with Thiamethoxam 25% WG applied at the rate of 100 were found to be less effective, however, they were superior to the untreated control. Maximum open boll damage and locule damage, i.e., 24.00 and 12.97 percent, were observed in the untreated control, respectively.

### Seed Cotton Yield:

Seed cotton yield was significantly greater in all the insecticidal treated plots over untreated plots. Highest seed cotton yield was recorded in the plots treated with 15% Fipronil+15% Flonicamid, WG at the rate of 500 g/ha (i.e. 15.67 q/ha), which was at par with the treatment of 15% Fipronil+15% Flonicamid, WG at the rate of 400 g/ha (i.e., 15.36 q/ha). The treatment with 15% Fipronil+15% Flonicamid, WG at the rate of 300 g/ha was the next greatest yield retaining treatment with 14.60 q/ha. Maximum cost benefit ratio was found in plots treated with 15% Fipronil+15% Flonicamid, WG applied at the rate of 400 g/ha followed by 15% Fipronil+15% Flonicamid, WG applied at the rate of 300 g/ha.

TABLE 11
Effect of Fipronil + Flonicamid WG on natural enemies in cotton
ecosystem

| | | Total Dose | Spiders/5 Plants | | | | Coccinellids/5 Plants | | |
|---|---|---|---|---|---|---|---|---|---|
| Sr. | | of actives | | 3 | 7 | 12 | 3 | 7 | 12 |
| No. | Treatment | ml or g/ha | BS | DAS | DAS | BS | DAS | DAS | DAS |
| 1. | 15% Fipronil + 15% | 300 | 3.33 | 2.92 | 3.00 | 2.00 | 1.33 | 1.50 | 1.67 |
| | Flonicamid, WG | | | | | | | | |
| 2. | 15% Fipronil + 15% | 400 | 3.67 | 3.17 | 3.25 | 1.33 | 0.83 | 1.00 | 1.10 |
| | Flonicamid, WG | | | | | | | | |
| 3. | 15% Fipronil + 15% | 500 | 4.33 | 3.67 | 3.75 | 2.33 | 1.37 | 1.67 | 1.83 |
| | Flonicamid, WG | | | | | | | | |
| 4. | Flonicamid 50% WG | 150 | 4.67 | 4.00 | 4.17 | 2.67 | 2.00 | 2.17 | 2.33 |
| 5 | Fipronil 5% SC | 1500 | 3.00 | 2.58 | 2.67 | 1.00 | 0.73 | 0.80 | 0.87 |
| 6. | Thiamethoxam 25% | 100 | 4.00 | 3.33 | 3.67 | 2.67 | 1.50 | 1.83 | 2.00 |
| | WG | | | | | | | | |
| 7. | Untreated Control | — | 5.00 | 4.67 | 5.33 | 1.67 | 2.00 | 2.17 | 2.33 |

| | | | | | | | | |
|---|---|---|---|---|---|---|---|---|
| CD at 5% | — | NS | NS | NS | NS | NS | NS | NS |

BS—Before spray.
DAS—Days after spray,
NS—Non-significant

No long-term adverse effect of any treatments were observed on the natural enemies (spiders, chrysopids, and coccinellids) prevailing in the cotton crop ecosystem. One of the reasons for the decrease in population of natural enemies may be assigned to decrease in pest population after the spraying of treatments. The present combination was found to be at par with the untreated control irrespective of days of observations and number of sprays.

It was thus found that the combination of fipronil and flonicamid demonstrated synergistic control of the whitefly and spotted bollworm population in cotton plants. It was further found that said combination demonstrated non-synergistic control of jassids and thrips. Said combination also resulted in improved yield while being economical. It also yielded favourable results on natural enemies of pests in cotton.

The use of the terms “a” and “an” and “the” and similar referents (especially in the context of the following claims) are to be construed to cover both the singular and the plural, unless otherwise indicated herein or clearly contradicted by context. The terms first, second etc. as used herein are not meant to denote any particular ordering, but simply for convenience to denote a plurality of, for example, layers. The terms “comprising”, “having”, “including”, and “containing” are to be construed as open-ended terms (i.e., meaning “including, but not limited to”) unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or 5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

1. A method for controlling whitefly and/or spotted bollworm insect pest in a cotton crop comprising contacting the insect pests with a wettable granular formulation comprising fipronil and flonicamid.

2. The method as claimed in claim 1, wherein the wettable granular formulation is applied to the cotton crop at a rate of 150 g/ha.

3. The method as claimed in claim 1, wherein the wettable granular formulation is synergistic in controlling the insect pests as compared to contacting the insect pests with a wettable granular flonicamid formulation or a suspension concentrate fipronil formulation.

4. The method as claimed in claim 1, wherein fipronil is applied at a dose of 45 to 100 g/ha and flonicamid is applied at a dose of 45 to 100 g/ha.

5. The method as claimed in claim 1, wherein the wettable granular formulation comprises 10-20 wt % flonicamid and 10-20 wt % fipronil, based on the total weight of the wettable granular formulation.

6. The method as claimed in claim 1, wherein the wettable granular formulation is applied to locules of the cotton crop at rate of 300-1000 g/ha.

7. The method as claimed in claim 1, wherein the contacting comprises a spray treatment, and wherein the spray treatment is repeated within a period of from 2 to 8 months from the first spray treatment.

8. The method as claimed in claim 1, wherein the wettable granular formulation exhibits synergistic control of whitefly and/or spotted bollworm, and non-synergistic control of jassids or thrips.

9. The method as claimed in claim 1, wherein the wettable granular formulation exhibits synergistic control of whitefly and/or spotted bollworm in the cotton crop.
